(19) United States
(12) Patent Application Publication
(10) Pub. No.: US 2025/0006909 A1
(43) Pub. Date: Jan. 2, 2025

(54) NEGATIVE ELECTRODE FOR LITHIUM METAL SECONDARY BATTERY, MANUFACTURING METHOD THEREFOR, AND LITHIUM METAL SECONDARY BATTERY

(71) Applicant: HONDA MOTOR CO., LTD., Tokyo (JP)

(72) Inventor: Kazuki SAIMEN, Saitama (JP)

(21) Appl. No.: 18/675,171

(22) Filed: May 28, 2024

(30) Foreign Application Priority Data
Jun. 28, 2023 (JP) 2023-106437

(51) Int. Cl. H01M 4/38; H01M 4/02; H01M 4/04; H01M 4/66; H01M 10/0525

(52) U.S. Cl. CPC H01M 4/382; H01M 4/0435; H01M 4/661; H01M 10/0525; H01M 2004/027

(57) ABSTRACT

A negative electrode for a lithium metal secondary battery according to an embodiment of the present invention includes a negative electrode current collector, and a lithium-containing metal layer disposed on at least one surface of the negative electrode current collector, at least a part of a surface of the lithium-containing metal layer has an uneven shape, the surface has a developed area ratio Sdr of 1.0 or more, and the surface is coated with an antioxidant film.

This application is based on and claims the benefit of priority from Japanese Patent Application No. 2023-106437, filed on 28 Jun. 2023, the content of which is incorporated herein by reference.

### BACKGROUND OF THE INVENTION

### Field of the Invention

The present invention relates to a negative electrode for a lithium metal secondary battery, a manufacturing method thereof, and a lithium metal secondary battery.

### Related Art

In recent years, research and development of a secondary battery that contributes to energy efficiency has been carried out to be able to secure access to handy, reliable, sustainable, and advanced energy by many people. As the secondary battery, a lithium metal secondary battery using lithium metal as a negative electrode active material has attracted attention because of a high energy density thereof.

As a negative electrode of the lithium metal secondary battery, a laminated negative electrode including a negative electrode current collector and a lithium layer disposed on at least one surface of the negative electrode current collector is known. It has been studied to provide unevenness on a surface of the lithium layer in the laminated negative electrode (Patent Document 1).
Patent Document 1: Japanese Unexamined Patent Application, Publication No. H7-272726

### SUMMARY OF THE INVENTION

Incidentally, improvement in discharge capacity, rate characteristics, and cycle characteristics is a challenge for the lithium metal secondary battery. In order to improve the discharge capacity and the rate characteristics of the lithium metal secondary battery, it is effective to increase a surface area of the lithium layer of the negative electrode and increase a reaction area of the negative electrode. However, when the surface area of the lithium layer of the negative electrode is increased, the lithium layer is easily oxidized. When the lithium layer is oxidized, surface resistance of the lithium layer increases, and there is a possibility that characteristics such as the discharge capacity, the rate characteristics, and the cycle characteristics deteriorate.

An object of the present application is to provide a negative electrode for a lithium metal secondary battery that has a large reaction area and is chemically stable, a manufacturing method thereof, and a lithium metal secondary battery having improved discharge capacity, rate characteristics, and cycle characteristics. Further, the present application contributes to energy efficiency.

In order to solve the above problem, the present inventor has found that it is effective to coat a surface of a lithium metal layer with an antioxidant film in accordance with increase in a surface area achieved by forming the surface of the lithium metal layer into an uneven shape, and the present invention was thus made. Therefore, the present invention provides the following.

(1) A negative electrode for a lithium metal secondary battery including: a negative electrode current collector; and a lithium-containing metal layer disposed on at least one surface of the negative electrode current collector, at least a part of a surface of the lithium-containing metal layer having an uneven shape, the surface having a developed area ratio Sdr of 1.0 or more, the surface being coated with an antioxidant film.

According to the negative electrode for a lithium metal secondary battery as described in aspect (1), at least a part of the surface of the lithium-containing metal layer has the uneven shape, the developed area ratio Sdr is 1.0 or more, and thus a surface area, that is, a reaction area of the lithium-containing metal layer is large. Further, at least a part of the surface of the lithium-containing metal layer is coated with the antioxidant film, and thus the lithium-containing metal layer is hardly oxidized and is chemically stable.

(2) The negative electrode for a lithium metal secondary battery as described in aspect (1), in which the surface of the lithium-containing metal layer has an arithmetic average roughness Sa of 0.5 μm or more.

According to the negative electrode for a lithium metal secondary battery as described in aspect (2), the arithmetic average roughness Sa of the surface having the uneven shape is large, and thus the reaction area of the lithium-containing metal layer is reliably increased. As the arithmetic average roughness Sa of the negative electrode for a lithium metal secondary battery increases, a contact angle with respect to an electrolytic solution decreases, and thus wettability of the electrolytic solution also improves.

(3) The negative electrode for a lithium metal secondary battery as described in aspect (1) or (2), in which the antioxidant film contains oxygen and carbon, and an average content of the oxygen with respect to an average content of the carbon in a range from a surface of the antioxidant film to a depth of 50 nm is 3 or more and 5 or less in molar ratio.

According to the negative electrode for a lithium metal secondary battery as described in aspect (3), the antioxidant film contains the oxygen (O) in an amount of 3 mol or more and 5 mol or less with respect to the carbon (C) in an amount of 1 mol, and is chemically stable because the carbon and the oxygen form a carbonate. Further, a thickness of the antioxidant film is 50 nm or more, and thus an antioxidant ability thereof is enhanced. Therefore, the surface of the lithium-containing metal layer is further hardly oxidized and is more chemically stable.

(4) The negative electrode for a lithium metal secondary battery as described in any one of aspects (1) to (3), in which the antioxidant film contains lithium carbonate.

According to the negative electrode for a lithium metal secondary battery as described in aspect (4), the antioxidant film contains lithium carbonate, and thus the antioxidant film is more chemically stable.

(5) The negative electrode for a lithium metal secondary battery as described in any one of aspects (1) to (4), in which a silicon content with respect to a lithium content in the lithium-containing metal layer is 400 ppm by mass or less in mass ratio.

According to the negative electrode for a lithium metal secondary battery as described in aspect (5), the silicon content is small, and thus the stability is increased and a change over time hardly occurs.

(6) The negative electrode for a lithium metal secondary battery as described in any one of aspects (1) to (5), in which peel strength between the negative electrode current collector and the lithium-containing metal layer is 100 N/cm or more.

According to the negative electrode for a lithium metal secondary battery as described in aspect (6), the peel strength between the negative electrode current collector and the lithium-containing metal layer is high, and thus electric characteristics are stabilized over a long period of time.

(7) A lithium metal secondary battery including: the negative electrode for a lithium metal secondary battery as described in any one of aspects (1) to (6) described above.

According to the lithium metal secondary battery as described in aspect (7), the negative electrode for a lithium metal secondary battery described above is included, and thus discharge capacity, rate characteristics, and cycle characteristics are improved.

(8) A method for manufacturing a negative electrode for a lithium metal secondary battery including a preparation step of preparing a laminate that includes a negative electrode current collector and a lithium-containing metal layer disposed on at least one surface of the negative electrode current collector; and an unevenness transfer step of pressing, against a surface of the laminate on a lithium-containing metal layer side, an unevenness transfer material that has an arithmetic average roughness Sa of 0.5 μm or more and includes an unevenness portion having a developed area ratio Sdr of 1.0 or more.

According to the manufacturing method of the negative electrode for a lithium metal secondary battery as described in aspect (8), in the unevenness transfer step, the unevenness transfer material including the unevenness portion whose developed area ratio Sdr is large is pressed against the lithium-containing metal layer, and thus the uneven shape can be stably formed on the surface of the lithium-containing metal layer.

(9) The method for manufacturing a negative electrode for a lithium metal secondary battery as described in aspect (8), in which a solvent having an ether bond or a carbonate ester bond is interposed between the surface of the laminate on the lithium-containing metal layer side and the unevenness transfer material in the unevenness transfer step.

According to the manufacturing method of the negative electrode for a lithium metal secondary battery as described in aspect (9), the solvent is interposed between the lithium-containing metal layer and the unevenness transfer material, and thus the lithium-containing metal layer and the unevenness transfer material are easily peeled off. In addition, the solvent has an ether bond or a carbonate ester bond, and thus when new lithium metal is exposed by pressing the unevenness transfer material against the lithium-containing metal layer, the lithium metal and the solvent react with each other and lithium carbonate is easily generated. Therefore, the antioxidant film can be stably formed on the surface of the lithium-containing metal layer.

(10) The method for manufacturing a negative electrode for a lithium metal secondary battery as described in aspect (8) or (9), in which a surface of the unevenness transfer material has an arithmetic average roughness Sa of 0.5 μm or more.

According to the manufacturing method of the negative electrode for a lithium metal secondary battery as described in aspect (10), the arithmetic average roughness Sa of the surface of the unevenness transfer material used in the unevenness transfer step is large, and thus the uneven shape can be further stably formed on the surface of the lithium-containing metal layer.

According to the present invention, it is possible to provide a negative electrode for a lithium metal secondary battery that has a large reaction area and is chemically stable, and a manufacturing method thereof. Further, according to the present invention, it is possible to provide a lithium metal secondary battery having improved discharge capacity, rate characteristics, and cycle characteristics.

### BRIEF DESCRIPTION OF THE DRAWINGS

FIG. 1 is a cross-sectional view illustrating a lithium metal secondary battery according to an embodiment of the present invention;

FIG. 2 is a cross-sectional SEM photograph illustrating a negative electrode for the lithium metal secondary battery according to the embodiment of the present invention; and

FIG. 3 is a schematic view illustrating a manufacturing device of the negative electrode for the lithium metal secondary battery that is capable of using a manufacturing method of the negative electrode for the lithium metal secondary battery according to the embodiment of the present invention.

### DETAILED DESCRIPTION OF THE INVENTION

An embodiment of the present invention will be described below with reference to the drawings.

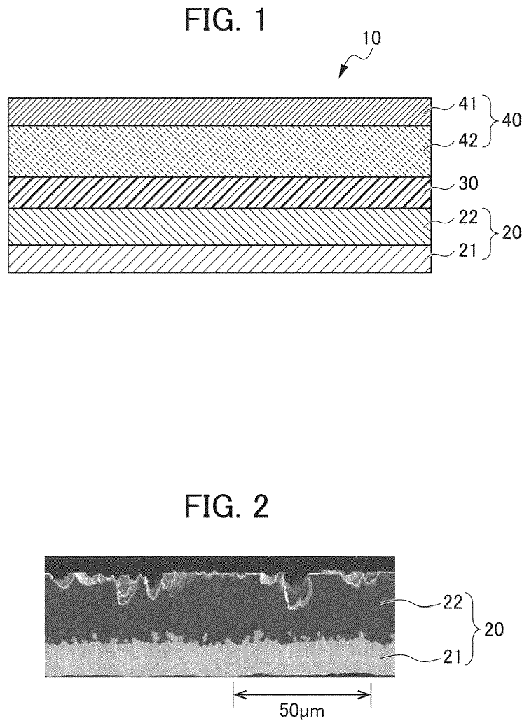

FIG. 1 is a cross-sectional view illustrating a lithium metal secondary battery according to an embodiment of the present invention. FIG. 2 is a cross-sectional SEM photograph illustrating a negative electrode for the lithium metal secondary battery according to the embodiment of the present invention. In FIG. 1, a lithium metal secondary battery 10 includes an electrode laminate in which a negative electrode 20, a separator 30, and a positive electrode 40 are laminated in this order. The electrode laminate is accommodated in an outer case (not shown) together with an electrolytic solution (not shown).

The negative electrode 20 includes a negative electrode current collector 21 and a lithium-containing metal layer 22 disposed on at least one surface of the negative electrode current collector 21.

The negative electrode current collector 21 is not particularly limited as long as the negative electrode current collector 21 has a function of collecting currents of the negative electrode 20, and a negative electrode current collector, which is used as a negative electrode current collector of a general lithium metal secondary battery, can be used. Examples of a material of the negative electrode current collector 21 include copper (Cu), stainless steel (SUS), and nickel (Ni). Examples of a shape of the negative electrode current collector 21 include a foil shape and a plate shape. When the negative electrode current collector 21 has a foil shape, a thickness of the negative electrode current collector 21 may be in a range of 5.0 μm or more and 50.0 μm or less. An arithmetic average roughness Sa of the negative electrode current collector 21 on a lithium-containing metal layer 22 side may be, for example, in a range of 0.2 μm or more and 2.0 μm or less. A maximum height Sz of the negative electrode current collector 21 on the lithium-containing metal layer 22 side may be, for example, ⅓ or more of the thickness, and may be in a range of 5.0 μm or more and 20.0 μm or less.

The lithium-containing metal layer 22 has an action of easily generating a lithium metal layer by depositing lithium ions moved from the positive electrode 40 on a surface of the negative electrode 20 during charging of the lithium metal secondary battery 10. Lithium in the lithium metal layer deposited on the surface of the negative electrode 20 is dissolved in the electrolytic solution during discharging of the lithium metal secondary battery 10. As illustrated in FIG. 2, at least a part of a surface of the lithium-containing metal layer 22 on a side opposite to a negative electrode current collector 21 side has an uneven shape, and a developed area ratio Sdr of the surface is set to 1.0 or more. A thickness of the lithium-containing metal layer 22 may be, for example, in a range of 5 μm or more and 50 μm or less. The developed area ratio Sdr of the surface having the uneven shape of the lithium-containing metal layer 22 may be in a range of 1.1 or more and 3.0 or less. An arithmetic average roughness Sa of the surface having the uneven shape of the lithium-containing metal layer 22 may be, for example, 0.5 μm or more, and may be in a range of 1.0 μm or more and 2.0 μm or less. A maximum height Sz of the surface having the uneven shape of the lithium-containing metal layer 22 may be, for example, ⅓ or more of the thickness, and may be in a range of 10.0 μm or more and 25.0 μm or less. The developed area ratio Sdr, the arithmetic average roughness Sa, and the maximum height Sz can be measured by using a commercially available laser microscope.

The lithium-containing metal layer 22 is coated with an antioxidant film (not shown). The antioxidant film prevents oxidation of the lithium-containing metal layer 22. Accordingly, the lithium-containing metal layer 22 is hardly oxidized even when the lithium metal secondary battery 10 is repeatedly charged and discharged.

The antioxidant film may contain oxygen (O) and carbon (C), and may contain lithium carbonate. An average content of the oxygen (O) with respect to an average content of the carbon (C) in a range from a surface of the antioxidant film (the surface of the lithium-containing metal layer 22) to a depth of 50 nm may be 3 or more and 5 or less in molar ratio (an O/C molar ratio). The O/C molar ratio within the range described above indicates that the antioxidant film contains a carbonate, and a thickness thereof is 50 nm or more. The O/C molar ratio can be confirmed by using, for example, X-ray photoelectron spectroscopy (XPS).

The lithium-containing metal layer 22 contains lithium or a lithium alloy. The lithium alloy contains a metal that forms an alloy with lithium. Examples of the metal that forms an alloy with lithium include Mg, Au, Ag, In, Ge, Sn, Pb, Al, and Zn. The lithium-containing metal layer 22 may contain an inevitable impurity. The inevitable impurity is a substance inevitably mixed in a raw material or a manufacturing process. Examples of the inevitable impurity include silicon. A silicon content with respect to a lithium content may be, for example, 400 ppm by mass or less in mass ratio (a Si/Li mass ratio).

The negative electrode current collector 21 and the lithium-containing metal layer 22 may be bonded to each other with a strong adhesion force. Peel strength between the negative electrode current collector 21 and the lithium-containing metal layer 22 may be, for example, 100 N/cm or more, and may be 200 N/cm or more.

The separator 30 is not particularly limited as long as the separator 30 prevents contact between the negative electrode 20 and the positive electrode 40 and allows the lithium ions to permeate therethrough, and a separator, which is used as a separator of the general lithium metal secondary battery, can be used. As the separator 30, for example, a porous sheet or a nonwoven fabric sheet can be used. Examples of a material of the porous sheet include polyolefins such as polyethylene and polypropylene, aramid, polyimide, and fluororesin. Examples of a material of the nonwoven fabric sheet include a glass fiber and a cellulose fiber. A surface of the separator 30 facing the positive electrode 40 may be coated with a ceramic material. Examples of a material for ceramic coating include aluminum oxide (Al₂O₃) and silicon oxide (SiO₂). A thickness of the ceramic coating may be, for example, in a range of 2.0 μm or more and 5.0 μm or less. When the thickness of the ceramic coating is in the range described above, thermal stability of the separator 30 can be improved while suppressing an increase in an internal resistance value due to an increase in a thickness of the separator 30.

The positive electrode 40 includes a positive electrode current collector 41 and a positive electrode active material layer 42 disposed on a surface of the positive electrode current collector 41 on a separator 30 side.

The positive electrode current collector 41 is not particularly limited as long as the positive electrode current collector 41 has a function of collecting currents of the positive electrode 40, and a positive electrode current collector, which is used as a positive electrode current collector of the general lithium metal secondary battery, can be used. Examples of a material of the positive electrode current collector 41 include aluminum, an aluminum alloy, stainless steel, nickel, iron, and titanium. Examples of a shape of the positive electrode current collector 41 include a foil shape and a plate shape.

The positive electrode active material layer 42 contains at least one type of positive electrode active material. The positive electrode active material is not particularly limited, and a positive electrode active material, which is used in a positive electrode layer of the general lithium metal secondary battery, can be used. As the positive electrode active material, for example, a layered active material, a spinel type active material, an olivine type active material, and the like which contain lithium can be used. Specific examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), heterogeneous element-substituted Li—Mn spinel represented by Li₁₊ₓMn_{2-x-y}MO₄ (x+y=2, M=at least one selected from Al, Mg, Co, Fe, Ni, and/or Zn), lithium titanate (oxides containing Li and Ti), and lithium metal phosphate (LiMPO₄, M=at least one selected from Fe, Mn, Co, and/or Ni).

The positive electrode active material layer 42 may freely contain a conductive auxiliary in order to improve conductivity. In addition, the positive electrode active material layer 42 may freely contain a binder from the viewpoint of exhibiting flexibility or the like. The conductive auxiliary and the binder are not particularly limited, and a conductive auxiliary and a binder, which are used in the positive electrode layer of the general lithium metal secondary battery, can be used.

The electrolytic solution contains an organic solvent and an electrolyte. As the organic solvent, for example, a cyclic carbonate, a chain carbonate, a cyclic ether, a chain ether, a hydrofluoroether, an aromatic ether, a sulfone, a cyclic ester, a chain carboxylic acid ester, and a nitrile can be used. Examples of the cyclic carbonate include an ethylene carbonate, a propylene carbonate, a vinylene carbonate, and a fluoroethylene carbonate. Examples of the chain carbonate include a dimethyl carbonate, a diethyl carbonate, and an ethyl methyl carbonate. Examples of the cyclic ether include tetrahydrofuran, 2-methyltetrahydrofuran, tetrahydropyran, 1,3-dioxolane, and 4-methyl-1,3-dioxolane. Examples of the chain ether include 1,2-dimethoxyethane, 1,2-diethoxyethane, ethoxymethoxyethane, and diethyl ether. Examples of the hydrofluoroether include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, and 1,2-bis(1,1,2,2-tetrafluoroethoxy) ethane. Examples of the aromatic ether include anisole. Examples of the sulfone include sulfolane, and methyl sulfolane. Examples of the cyclic ester include γ-butyrolactone. Examples of the chain carboxylic acid ester include an acetate ester, a butyrate ester, and a propionate ester. Examples of the nitrile include acetonitrile and propionitrile. The organic solvent may be used alone, and may be used in combination of two or more types thereof.

The electrolyte is a supply source of the lithium ions as charge transfer media, and contains a lithium salt. Examples of the lithium salt include LiPF₆, LiBF₄, LiClO₄, LiAsF₆, LiCF₃SO₃, LiC(CF₃SO₂)₃, LIN(CF₃SO₂)₂(LiTFSI), LIN(FSO₂)₂(LiFSI), and LiBC₄O₈. The lithium salt may be used alone, and may be used in combination of two or more types thereof. The concentration of the electrolyte is, for example, in a range of 1.5 to 4.0 mol/L.

According to the lithium metal secondary battery 10 of the present embodiment having the configuration described above, at least a part of the surface of the lithium-containing metal layer 22 in the negative electrode 20 has the uneven shape, the developed area ratio Sdr is 1.0 or more, and a surface area, that is, a reaction area of the lithium-containing metal layer 22 is large. Further, at least a part of the surface of the lithium-containing metal layer 22 is coated with the antioxidant film, and thus the lithium-containing metal layer 22 is hardly oxidized and is chemically stable. Therefore, in the lithium metal secondary battery 10, lithium is likely to be uniformly deposited on the surface of the lithium-containing metal layer 22 during the charging, and deposited lithium is likely to be uniformly dissolved during the discharging. Accordingly, discharge capacity, rate characteristics, and cycle characteristics of the lithium metal secondary battery 10 are improved.

In the lithium metal secondary battery 10 according to the present embodiment, when the lithium-containing metal layer 22 has the large arithmetic average roughness Sa of 0.5 μm or more, the reaction area of the lithium-containing metal layer 22 is reliably increased, and thus the discharge capacity and the rate characteristics of the lithium metal secondary battery 10 are further improved. Further, as the arithmetic average roughness Sa of the lithium-containing metal layer 22 increases, a contact angle with respect to the electrolytic solution decreases, and thus wettability of the electrolytic solution also improves.

In the lithium metal secondary battery 10 according to the present embodiment, when the average content of the oxygen (O) with respect to the average content of the carbon (C) in the range from the surface of the antioxidant film (the surface of the lithium-containing metal layer 22) to the depth of 50 nm is 3 or more and 5 or less in molar ratio (the O/C molar ratio), the antioxidant film contains the oxygen (O) in an amount of 3 mol or more and 5 mol or less with respect to the carbon (C) in an amount of 1 mol, and is chemically stable because the carbon and the oxygen form a carbonate. Further, the thickness of the antioxidant film is 50 nm or more, and thus an antioxidant ability thereof is enhanced. Therefore, the surface of the lithium-containing metal layer 22 is further hardly oxidized and is more chemically stable. Accordingly, the cycle characteristics of the lithium metal secondary battery 10 are further improved. When the antioxidant film contains lithium carbonate, the antioxidant film is more chemically stable. Accordingly, the cycle characteristics of the lithium metal secondary battery 10 are further improved.

In the lithium metal secondary battery 10 according to the present embodiment, when the silicon content with respect to the lithium content of the lithium-containing metal layer 22 is as small as 400 ppm by mass or less in mass ratio, the stability of the lithium-containing metal layer 22 is increased and a change over time hardly occurs. Accordingly, the cycle characteristics of the lithium metal secondary battery 10 are further improved.

In the lithium metal secondary battery 10 according to the present embodiment, when the peel strength between the negative electrode current collector 21 and the lithium-containing metal layer 22 is as high as 100 N/cm, electric characteristics are stabilized over a long period of time. Accordingly, the cycle characteristics of the lithium metal secondary battery 10 are further improved.

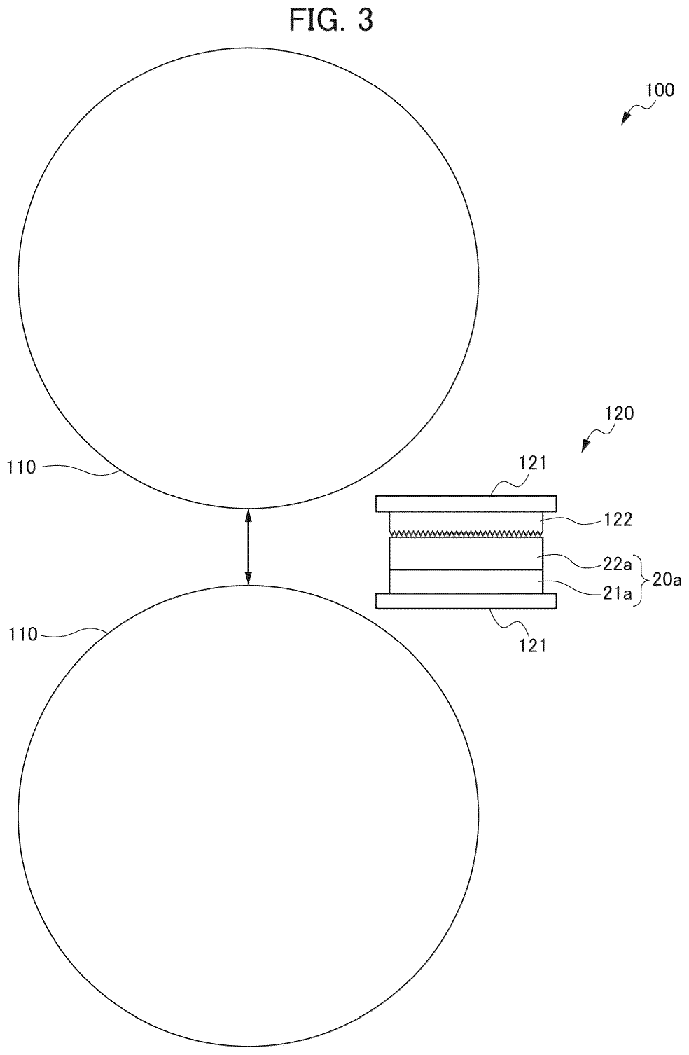

Next, a manufacturing method of the negative electrode 20 for the lithium metal secondary battery will be described. FIG. 3 is a schematic view illustrating a manufacturing device of the negative electrode for the lithium metal secondary battery that is capable of using the manufacturing method of the negative electrode for the lithium metal secondary battery according to the embodiment of the present invention. As illustrated in FIG. 3, a manufacturing device 100 includes a pair of roll presses 110 and an unevenness forming laminate 120. The unevenness forming laminate 120 includes a negative electrode material laminate 20a and an unevenness transfer material 122 disposed between a pair of mold release plates 121. The negative electrode material laminate 20a includes a negative electrode current collector 21a and a lithium-containing metal layer 22a disposed on one surface of the negative electrode current collector 21a. The unevenness transfer material 122 has an unevenness portion on one surface thereof, and is disposed such that the lithium-containing metal layer 22a and the unevenness portion of the unevenness transfer material 122 are in contact with each other. The unevenness portion of the unevenness transfer material 122 has a developed area ratio Sdr of 1.0 or more. The developed area ratio Sdr of the unevenness portion of the unevenness transfer material 122 may be in a range of 1.1 or more and 3.0 or less. An arithmetic average roughness Sa of the unevenness portion of the unevenness transfer material 122 may be, for example, 0.5 μm or more, and may be in a range of 1.0 μm or more and 2.0 μm or less. A maximum height Sz of the unevenness portion of the unevenness transfer material 122 may be, for example, in a range of 5.0 μm or more and 25.0 μm or less. As the mold release plates 121, for example, copper plates can be used.

The negative electrode 20 for the lithium metal secondary battery can be manufactured by, for example, a method including a preparation step and an unevenness transfer step.

The preparation step is a step of preparing the negative electrode material laminate 20a. The negative electrode material laminate 20a can be manufactured, for example, by overlapping the negative electrode current collector 21a and the lithium-containing metal layer 22a and applying a pressure thereto.

The unevenness transfer step is a step of manufacturing the unevenness forming laminate 120 and pressing the unevenness forming laminate 120 with the roll presses 110 to press the unevenness transfer material 122 against a surface of the lithium-containing metal layer 22a. An uneven shape of the unevenness portion of the unevenness transfer material 122 is transferred to the surface of the lithium-containing metal layer 22a by pressing the unevenness transfer material 122 against the surface of the lithium-containing metal layer 22a. A condition for the pressing is not particularly limited, and refers to a condition under which a compression rate of the unevenness forming laminate 120 by the pressing is, for example, in a range of 30% or more and 50% or less. When the compression rate is in this range, the uneven shape is easily transferred to the surface of the lithium-containing metal layer 22a without peeling off the lithium-containing metal layer 22a from the negative electrode current collector 21a. The compression rate of the lithium-containing metal layer 22a can be adjusted by a distance (indicated by the arrow in FIG. 3) between the pair of roll presses 110.

In the unevenness transfer step, a solvent may be interposed between the lithium-containing metal layer 22a and the unevenness transfer material 122 before the unevenness transfer material 122 is pressed against the surface of the lithium-containing metal layer 22a. The solvent may have an ether bond or a carbonate ester bond. As the solvent having an ether bond, for example, DME (1,2-dimethoxyethane) can be used. As the solvent having a carbonate ester bond, for example, dimethyl carbonate can be used.

According to the manufacturing method of the negative electrode 20 for the lithium metal secondary battery of the present embodiment having the configuration described above, in the unevenness transfer step, the unevenness transfer material 122 having the large developed area ratio Sdr is pressed against the lithium-containing metal layer 22a, and thus the uneven shape can be stably formed on the surface of the lithium-containing metal layer 22.

In the manufacturing method of the negative electrode 20 for the lithium metal secondary battery according to the present embodiment, when the solvent having an ether bond or a carbonate ester bond is interposed between the lithium-containing metal layer 22a and the unevenness transfer material 122, the lithium-containing metal layer 22a and the unevenness transfer material 122 after the uneven shape is formed are likely to be easily peeled off. In addition, the solvent has an ether bond or a carbonate ester bond, and thus when new lithium metal is exposed by pressing the unevenness transfer material 122 against the lithium-containing metal layer 22a, the lithium metal and the solvent react with each other and lithium carbonate is easily generated. Therefore, the antioxidant film can be stably formed on the surface of the lithium-containing metal layer 22a after the uneven shape is formed. In addition, in the manufacturing method of the negative electrode 20 for the lithium metal secondary battery according to the present embodiment, when a surface of the unevenness transfer material 122 has a large arithmetic average roughness Sa of 1.0 μm or more, the uneven shape can be more stably formed on the surface of the lithium-containing metal layer.

Although the embodiment of the present invention has been described above, the present invention is not limited to the above embodiment. For example, the lithium metal secondary battery 10 according to the present embodiment is a nonaqueous solvent type lithium metal secondary battery including an electrolytic solution, but the present invention is not limited thereto. The lithium metal secondary battery of the present invention may be a solid electrolyte type lithium metal secondary battery.

Although in the manufacturing method of the negative electrode 20 for the lithium metal secondary battery according to the present embodiment, the solvent having an ether bond or a carbonate ester bond is interposed between the lithium-containing metal layer 22a and the unevenness transfer material 122, the present invention is not limited thereto. However, when a solvent not having an ether bond or a carbonate ester bond is used, it is preferable to provide a step of forming the antioxidant film on the surface of the lithium-containing metal layer 22a after the uneven shape is formed. As a method of forming the antioxidant film, for example, a method of bringing a carbon dioxide gas into contact with the surface of the lithium-containing metal layer 22a after the uneven shape is formed can be used. In addition, in the manufacturing method of the negative electrode 20 for the lithium metal secondary battery according to the present embodiment, the roll presses 110 are used as a press device for the unevenness forming laminate 120, but the press device is not limited thereto.

### Examples

In the present example, a Li—Cu laminate in which a Li foil was disposed on a surface of a Cu foil was used as a raw material of the negative electrode. As the Li—Cu laminate, two laminates, that is, Li—Cu laminates 1 and 2 were used. A thickness, an arithmetic average roughness Sa, and a maximum height Sz of the Cu foil, a thickness, an arithmetic average roughness Sa, a maximum height Sz, and a developed area ratio Sdr of the Li foil, and a Li—Cu interfacial peel strength in each of the Li—Cu laminates 1 and 2 used in the present example are shown in the following Table 1. The arithmetic average roughness Sa and the maximum height Sz of the Cu foil are values of a surface on a Li foil side. The arithmetic average roughness Sa, the maximum height Sz, and the developed area ratio Sdr of the Li foil are values of a surface on a side opposite to a Cu foil side. In the present example, the arithmetic average roughness Sa, the maximum height Sz, and the developed area ratio Sdr were measured by using a laser microscope (VK-X3000, manufactured by KEYENCE CORPORATION).

TABLE 1

| | Cu foil | | | Li foil | | | | |
|---|---|---|---|---|---|---|---|---|
| | | Arithmetic | | | Arithmetic | | | Li—Cu |
| | | average | Maximum | | average | Maximum | Developed | peel |
| | Thickness | roughness | height | Thickness | roughness | height | area ratio | strength |
| | (μm) | Sa(μm) | Sz(μm) | (μm) | Sa(μm) | Sz(μm) | Sdr(—) | (N/m) |
| Li—Cu | 14 | 0.93 | 13.90 | 20 | 0.10 | 5.10 | 0.004 | >200 |
| laminate 1 | | | | | | | | |
| Li—Cu | 10 | 0.43 | 5.80 | 20 | 0.40 | 4.00 | 0.008 | 70 |
| laminate 2 | | | | | | | | |

In the present example, as the unevenness transfer material, three transfer materials, that is, unevenness transfer materials 1 to 3 were used. An arithmetic average roughness Sa, a maximum height Sz, and a developed area ratio Sdr of each of the unevenness transfer materials 1 to 3 used in the present example are shown in the following Table 2. Each of the unevenness transfer materials 1 to 3 is made of an electrolytic nickel foil.

TABLE 2

| | Arithmetic | | Developed |
|---|---|---|---|
| | average | Maximum | area |
| | roughness | height | ratio |
| | Sa (μm) | Sz (μm) | Sdr (—) |
| Unevenness transfer material 1 | 1.33 | 15.75 | 0.35 |
| Unevenness transfer material 2 | 1.95 | 19.08 | 2.34 |
| Unevenness transfer material 3 | 1.52 | 15.66 | 1.44 |

### Example 1

DME (1,2-dimethoxyethane) was dropped onto a surface of a Li layer of the Li—Cu laminate 1. Next, the surface of the Li layer of the Li—Cu laminate 1 and an unevenness portion of the unevenness transfer material 2 were overlapped and sandwiched by mold release copper foils each having a thickness of 20 μm to obtain an unevenness forming laminate in which the mold release copper foil, the Li—Cu laminate 1, the unevenness transfer material 2, and the mold release copper foil were laminated in this order. The obtained unevenness forming laminate was pressurized at a linear pressure of 1 t/cm by using the roll presses such that the compression rate was 45%. The mold release copper foils and the unevenness transfer material 2 were peeled off from the pressurized unevenness forming laminate to obtain a Li—Cu laminate with unevenness in which the unevenness is transferred onto the surface of the Li layer.

### Examples 2 to 4 and Comparative Examples 1 and 2

Li—Cu laminates with unevenness were obtained in the same manner as in Example 1 except that the type of the Li—Cu laminate, the type of the solvent dropped onto the surface of the Li layer of the Li—Cu laminate, the type of the unevenness transfer material, and the compression rate were changed as shown in the following Table 3.

### Comparative Example 3

The Li—Cu laminate 2 was used as a Li—Cu laminate of Comparative Example 3.

### Comparative Example 4

The Li—Cu laminate 2 was sandwiched by the mold release copper foils to obtain a compression laminate in which the mold release copper foil, the Li—Cu laminate 2, and the mold release copper foil were laminated in this order. The obtained compression laminate was pressurized at the linear pressure of 1 t/cm by using the roll presses such that the compression rate was 418. When the mold release copper foils were peeled off from the pressurized compression laminate, the Li foil was peeled off from the Cu foil of the Li—Cu laminate 2.

### Comparative Example 5

The Li—Cu laminate 1 was compressed in the same manner as in Comparative Example 4 except that the Li—Cu laminate 1 was used. The compressed Li—Cu laminate 1 was used as a Li—Cu laminate of Comparative Example 5.

TABLE 3

| | | | Type of | |
|---|---|---|---|---|
| | Type of | | unevenness | Compression |
| | Li—Cu | | transfer | rate |
| | laminate | Type of solvent | material | (%) |
| Example 1 | 1 | DME | 2 | 45 |
| Example 2 | 1 | DME | 2 | 41 |
| Example 3 | 1 | DME | 3 | 41 |
| Example 4 | 1 | DMC | 2 | 41 |
| Comparative | 1 | DME | 1 | 45 |
| Example 1 | | | | |
| Comparative | 1 | 2.5M-LiFSI/ | 3 | 41 |
| Example 2 | | DME | | |

| | | | |
|---|---|---|---|
| Comparative | 2 | Unevenness was not transferred | Not |
| Example 3 | | onto surface of Li layer | compressed |
| Comparative | 2 | Unevenness was not transferred | 41 |
| Example 4 | | onto surface of Li layer | |
| Comparative | 1 | Unevenness was not transferred | 41 |
| Example 5 | | onto surface of Li layer | |

### [Evaluation]

### (1) Characteristics of Li Layer of Li—Cu Laminate

Regarding the Li—Cu laminates with unevenness obtained in Examples 1 to 4 and Comparative Examples 1 and 2, and the Li—Cu laminates in Comparative Examples 3 and 5, the arithmetic average roughness Sa, the maximum height Sz, and the developed area ratio Sdr of the Li layer, the O/C (oxygen/carbon) molar ratio, and the Si/Li mass ratio were measured by the method described above. The arithmetic average roughness Sa, the maximum height Sz, and the developed area ratio Sdr were measured by using the laser microscope (VK-X3000, manufactured by KEYENCE CORPORATION). Regarding the O/C (oxygen/carbon) molar ratio, the molar ratio of the carbon (C) and the oxygen (O) in a range from a surface of the Li foil to a depth of 50 nm was measured by using XPS method. The Si/Li mass ratio was calculated based on a Si amount and a Li amount of the Li—Cu laminate with unevenness. The Si amount and the Li amount were obtained by dissolving the Li—Cu laminate with unevenness in an acid and measuring the amounts of Si and Li in the obtained solution using an ICP emission spectrometer. Results thereof are shown in the following Table 4.

### (2) Characteristics of Lithium Metal Secondary Battery (Positive Electrode)

Acetylene black (AB) as an electron conductive material, polyvinylidene fluoride (PVDF) as a binding agent (the binder), and polyvinylpyrrolidone (PVP) as a dispersant were preliminarily mixed in N-methyl-2-pyrrolidone (NMP) as a dispersion solvent, and were wet-mixed with a rotation-revolution mixer to obtain a preliminarily mixed slurry. Subsequently, Li₁Ni_{0.8}CO_{0.1}Mn_{0.1}O₂ (NCM811) as a positive electrode active material and the obtained preliminarily mixed slurry were mixed, and a dispersion process was performed by using a planetary mixer to obtain a positive electrode paste. The NCM811 has a median diameter of 12 μm. Next, the obtained positive electrode paste was applied to an aluminum positive electrode current collector without a primer layer and dried, the obtained aluminum positive electrode current collector was pressurized by the roll presses, and then the obtained aluminum positive electrode current collector was dried in a vacuum at 120° C. to form a positive electrode plate having a positive electrode active material layer. The obtained positive electrode plate was punched into a size of 30 mm×40 mm to obtain a positive electrode.

### (Separator)

A separator was used, which included polyethylene (PE) having a thickness of 10 μm and a porosity of 45% as a resin portion, with a 4 μm ceramic coating on the surface facing the positive electrode.

### (Electrolytic Solution)

A solution obtained by dissolving LiFSI [lithium bis(fluorosulfonyl) imide] in DME (1,2-dimethoxyethane) at a concentration of 2.5 mol/L was used.

### (Manufacture of Lithium Metal Secondary Battery)

The separator described above and the positive electrode described above were laminated in this order on the Li layer of each of the Li—Cu laminates with unevenness obtained in Examples 1 to 4 and Comparative Examples 1 and 2 and the Li—Cu laminates in Comparative Examples 3 and 5 to obtain an electrode laminate. The obtained electrode laminate and the electrolytic solution described above were accommodated in an outer case, and the outer case was sealed to manufacture the lithium metal secondary battery.

### (Formation Step of Lithium Metal Secondary Battery)

The manufactured lithium metal secondary battery was held at a holding pressure of 50 kPa and was allowed to stand at a temperature (25° C.) for 24 hours. Next, after constant current charging was performed at 2.2 mA to 4.3 V, constant voltage charging was subsequently performed at a voltage of 4.3 V for 1 hour, and the lithium metal secondary battery was allowed to stand for 30 minutes, constant current discharging was performed at a current value of 44 mA to 2.65 V. This charging and discharging cycle was repeated 3 times.

### (Initial Discharge Capacity)

The lithium metal secondary battery after the formation step was allowed to stand at a holding pressure of 0.8 MPa and a temperature (25° C.) for 1 hour. Next, a discharge capacity in a case in which after the constant current charging was performed at 14.5 mA to 4.3 V, the constant voltage charging was subsequently performed at a voltage of 4.3 V for 1 hour, and the lithium metal secondary battery was allowed to stand for 30 minutes, the constant current discharging was performed at a current value of 14.5 mA to 2.65 V, was set to an initial discharge capacity (mAh). Results thereof are shown in Table 5. Hereinafter, a current value at which the discharging can be completed in 1 hour with respect to the obtained initial discharge capacity was defined as 1C.

### (Initial Internal Resistance Value)

The lithium metal secondary battery after the measurement of the initial discharge capacity was charged at 0.2 C after being allowed to stand at a temperature (25° C.) for 1 hour, a state of charge [SOC] thereof was adjusted to 50%, and then the lithium metal secondary battery was allowed to stand for 10 minutes. Next, pulse discharging was performed for 10 seconds at a C rate of 0.5 C, and a voltage during the discharging for 10 seconds was measured. The voltage during the discharging for 10 seconds with respect to a current at 0.5 C was plotted when the horizontal axis represents the current value and the vertical axis represents the voltage. Next, after the lithium metal secondary battery was allowed to stand for 10 minutes, auxiliary charging was performed to return the SOC to 50%, and then the lithium metal secondary battery was allowed to further stand for 10 minutes. The above operation was performed at each C rate of 1.0 C, 1.5 C, 2.0 C, 2.5 C, and 3.0 C, and the voltage during the discharging for 10 seconds with respect to a current value at each C rate was plotted. Further, an inclination of an approximate straight line obtained from each plotting by the least squares method was defined as an internal resistance value (Ω·cm²) of the lithium ion secondary battery obtained according to the present example. Results thereof are shown in Table 5.

### (Charging and Discharging Cycle Test at High Rate)

Regarding the charging, the constant current charging was performed at 74 mA to 3.823 V, and the charging was subsequently performed at 52 mA to 4.051 V. Then, the constant current charging was performed at 46 mA to 4.173 V, and then the charging was performed at 22 mA to 4.3 V. Then, CV charging was performed at 4.3 V for 90 minutes. Regarding the discharging, the constant current discharging was performed at a current value of 18 mA to 2.65 V. The above was repeated 48 times. The discharge capacity at the second cycle, the discharge capacity at the 48th cycle, and the ratio of the discharge capacity at the 48th cycle to the discharge capacity at the second cycle (a discharge capacity retention ratio) are shown in Table 5.

(Internal Resistance Value after Cycle Test)

Regarding the lithium metal secondary battery after the charging and discharging cycle test at the high rate described above was performed, the operation of performing the constant current charging at 14.5 mA to 4.3 V, subsequently performing the constant voltage charging at the voltage of 4.3 V for 1 hour and allowing the lithium metal secondary battery to stand for 30 minutes, and then performing the constant current discharging at the current value of 14.5 mA to 2.65 V was executed at two cycles. Regarding the lithium metal secondary battery after the two cycles, the internal resistance value was measured in the same manner as the initial internal resistance value described above. The obtained internal resistance value was set as the internal resistance value after the cycle test, and the ratio (a variation rate) of the internal resistance value after the cycle test to the initial internal resistance value was calculated. Results thereof are shown in Table 5.

TABLE 4

| | Characteristics of Li layer of Li—Cu laminate | | | | |
|---|---|---|---|---|---|
| | Arithmetic | | Developed | | |
| | average | Maximum | area | O/C | Si/Li |
| | roughness | height | ratio | molar | mass |
| | Sa | Sz | Sdr | ratio | ratio |
| | (μm) | (μm) | (—) | (—) | (ppm) |
| Example 1 | 1.65 | 17.00 | 2.10 | 4.1 | 214 |
| Example 2 | 1.19 | 14.53 | 1.41 | 4.8 | 256 |
| Example 3 | 0.91 | 9.10 | 1.00 | 5.0 | 390 |
| Example 4 | 1.30 | 15.30 | 1.40 | 3.0 | 215 |
| Comparative | 1.30 | 13.60 | 0.37 | 4.0 | 350 |
| Example 1 | | | | | |
| Comparative | 0.90 | 10.00 | 1.00 | 9.1 | 550 |
| Example 2 | | | | | |
| Comparative | 0.40 | 4.00 | 0.008 | 5.7 | 36 |
| Example 3 | | | | | |
| Comparative | Unmeasurable because Li foil was peeled | | | | |
| Example 4 | off from Cu foil of Li—Cu laminate | | | | |
| Comparative | 0.10 | 0.05 | 0.004 | 29.5 | 653 |
| Example 5 | | | | | |

TABLE 5

| | Characteristics of lithium metal secondary battery | | | | | | |
|---|---|---|---|---|---|---|---|
| | Initial | Internal resistance value | | | Charging and discharging cycle test at high rate | | |
| | discharge | | After cycle | Variation | Discharge | Discharge | |
| | capacity | Initialization | test | rate | capacity at 2nd | capacity at 48th | Discharge capacity |
| | (mAh) | (Ω · cm²) | (Ω · cm²) | (%) | cycle(mAh/g) | cycle(mAh/g) | retention ratio(%) |
| Example 1 | 45.2 | 17.5 | 17.2 | 98.3 | 41.6 | 20.4 | 49.0 |
| Example 2 | 44.4 | 20.5 | 20.4 | 99.5 | 38.5 | 9.9 | 25.7 |
| Example 3 | 45.1 | 19.2 | 18.3 | 95.5 | 37.4 | 11.5 | 30.7 |
| Example 4 | 45.3 | 17.7 | 18.4 | 104.0 | 40.1 | 16.5 | 41.1 |
| Comparative | 45.3 | 18.7 | 20.4 | 109.1 | 36.4 | 3.9 | 10.7 |
| Example 1 | | | | | | | |
| Comparative | 45.2 | 18.1 | 20.3 | 112.2 | 35.5 | 4.5 | 12.7 |
| Example 2 | | | | | | | |
| Comparative | 45.3 | 15.0 | 19.9 | 132.7 | 32.7 | 5.0 | 15.3 |
| Example 3 | | | | | | | |

| | |
|---|---|
| Comparative | Unmeasurable because Li foil was peeled off from Cu foil of Li—Cu laminate |
| Example 4 | |
| Comparative | Unmeasurable because charging was impossible |
| Example 5 | |

Regarding the lithium metal secondary battery using each of the Li—Cu laminates with unevenness obtained in Examples 1 to 4 as the negative electrode, the discharge capacity and the discharge capacity retention ratio at the 48th cycle of the charging and discharging cycle test at the high rate are high, and the variation rate of the internal resistance value due to the charging and discharging cycle test at the high rate is small. According to this result, it is understood that the lithium metal secondary battery using each of the Li—Cu laminates with unevenness obtained in Examples 1 to 4 as the negative electrode has a high capacity and excellent rate characteristics and cycle characteristics. On the other hand, regarding the lithium metal secondary battery using each of the Li—Cu laminates with unevenness in Comparative Examples 1 and 2 and the Li—Cu laminate in Comparative Example 3, the discharge capacity and the discharge capacity retention ratio at the 48th cycle of the charging and discharging cycle test at the high rate are low, and the variation rate of the internal resistance value due to the charging and discharging cycle test at the high rate is large. The reason why characteristics related to Comparative Example 1 in the charging and discharging cycle test at the high rate are inferior is considered to be that the Li—Cu laminate with unevenness in Comparative Example 1 has a small developed area ratio Sdr and a small reaction area. The reason why characteristics related to Comparative Example 2 in the charging and discharging cycle test at the high rate are inferior is considered to be that since the Li—Cu laminate with unevenness in Comparative Example 2 has a large O/C molar ratio, a surface thereof is oxidized to generate components such as LiOH and Li₂O, and lithium ions are less likely to be uniformly deposited during the charging. The reason why characteristics related to Comparative Example 3 in the charging and discharging cycle test at the high rate are inferior is considered to be that the Li—Cu laminate in Comparative Example 3 has no unevenness on a surface thereof and has a small reaction area. In Comparative Example 5, the charging to 4.3 V could not be performed in the formation step of the lithium metal secondary battery. It is considered that no uneven shape was formed on the surface of the Li layer of the Li—Cu laminate in Comparative Example 5, the O/C molar ratio was large, and thus lithium ions were non-uniformly deposited during the charging, and an internal short circuit occurred.

### EXPLANATION OF REFERENCE NUMERALS

10 lithium metal secondary battery
20 negative electrode
20a negative electrode material laminate
21, 21a negative electrode current collector
22, 22a lithium-containing metal layer
30 separator
40 positive electrode
41 positive electrode current collector
42 positive electrode active material layer
100 manufacturing device
110 roll press
120 unevenness forming laminate
121 mold release plate
122 unevenness transfer material

What is claimed is:

1. A negative electrode for a lithium metal secondary battery comprising: a negative electrode current collector; and a lithium-containing metal layer disposed on at least one surface of the negative electrode current collector,
at least a part of a surface of the lithium-containing metal layer having an uneven shape, the surface having a developed area ratio Sdr of 1.0 or more, the surface being coated with an antioxidant film.

2. The negative electrode for a lithium metal secondary battery according to claim 1, wherein the surface of the lithium-containing metal layer has an arithmetic average roughness Sa of 0.5 μm or more.

3. The negative electrode for a lithium metal secondary battery according to claim 1, wherein the antioxidant film contains oxygen and carbon, and an average content of the oxygen with respect to an average content of the carbon in a range from a surface of the antioxidant film to a depth of 50 nm is 3 or more and 5 or less in molar ratio.

4. The negative electrode for a lithium metal secondary battery according to claim 1, wherein the antioxidant film contains lithium carbonate.

5. The negative electrode for a lithium metal secondary battery according to claim 1, wherein a silicon content with respect to a lithium content in the lithium-containing metal layer is 400 ppm by mass or less in mass ratio.

6. The negative electrode for a lithium metal secondary battery according to claim 1, wherein peel strength between the negative electrode current collector and the lithium-containing metal layer is 100 N/cm or more.

7. A lithium metal secondary battery comprising: the negative electrode for a lithium metal secondary battery according to claim 1.

8. A method for manufacturing a negative electrode for a lithium metal secondary battery comprising: a preparation step of preparing a laminate that includes a negative electrode current collector and a lithium-containing metal layer disposed on at least one surface of the negative electrode current collector;
an unevenness transfer step of pressing, against a surface of the laminate on a lithium-containing metal layer side, an unevenness transfer material that includes an unevenness portion having a developed area ratio Sdr of 1.0 or more.

9. The method for manufacturing a negative electrode for a lithium metal secondary battery according to claim 8, wherein a solvent having an ether bond or a carbonate ester bond is interposed between the surface of the laminate on the lithium-containing metal layer side and the unevenness transfer material in the unevenness transfer step.

10. The method for manufacturing a negative electrode for a lithium metal secondary battery according to claim 8, wherein a surface of the unevenness transfer material has an arithmetic average roughness Sa of 0.5 μm or more.
